(19) United States
(12) Patent Application Publication
(10) Pub. No.: US 2025/0135657 A1
(43) Pub. Date: May 1, 2025

(54) TOOL CHANGER FOR ROBOTIC ARM

(71) Applicant: Machina Labs, Inc., Chatsworth, CA (US)

(72) Inventors: Kyle Hickey, Moorpark, CA (US); Aaron David Keit, Simi Valley, CA (US)

(21) Appl. No.: 18/931,286

(22) Filed: Oct. 30, 2024

Related U.S. Application Data
(60) Provisional application No. 63/594,922, filed on Oct. 31, 2023.

(51) Int. Cl. B25J 15/04

(52) U.S. Cl. CPC B25J 15/0408

(57) ABSTRACT

A tool holder assembly may include: an internal cavity, a drawbar in the internal cavity and extending through a tunnel at a first cavity end of the internal cavity, a spring positioned in the internal cavity to press or pull the drawbar away from the tunnel and toward a second cavity end opposite the first cavity end, a piston in the internal cavity and positioned between the drawbar and the second cavity end; and a port configured to allow fluid to enter the internal cavity between the piston and the second cavity end.

### CROSS-REFERENCE TO RELATED APPLICATION

This application claims the benefit of, and priority to, U.S. Provisional Patent Application Ser. No. 63/594,922, “Sheet Part Forming Components and Methods,” filed Oct. 31, 2023, which is incorporated herein by reference in its entirety.

### TECHNICAL FIELD

This disclosure relates generally to robotic systems, and, more particularly, to robotic systems with tool changers.

### BACKGROUND

Sheet metal parts are used in a multitude of applications and across many different industries (e.g., in aerospace, automotive, biomedical, and consumer electronics industries). Sheet metal part forming is the manufacturing process through which sheet metal parts are made. However, sheet metal part forming is very tool intensive, which makes it costly and time consuming to fabricate sheet metal parts. A method for sheet metal part forming is stamping. In stamping, a series of female and male dies that are specific to each design and material are fabricated (tooling). A sheet metal part is formed in a press machine by sandwiching sheet metal between the two dies with force. Stamping requires a large investment in dies and is not accommodating to changes in design and material, making the sheet metal forming process expensive and time-consuming.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1 is a perspective view of a robotic setup for part forming, according to an embodiment.

FIG. 2A is block diagram of a model, according to an embodiment.

FIG. 2B is a block diagram of a part forming process, according to an embodiment.

FIG. 3 is an image from a simulated part forming process, according to an embodiment.

FIG. 4 is a perspective view of a robotic setup with optical trackers, according to an embodiment.

FIG. 5A is a perspective view of a robot arm with a scanner and load sensor, according to an embodiment.

FIG. 5B is an image generated using scanner data, according to an embodiment.

FIG. 6 includes plots of different forming paths to form a cone, according to an embodiment.

FIGS. 7A-7D illustrate a forming process, according to an embodiment.

FIGS. 8A-8B are perspective views of first and second roller tools, according to some embodiments.

FIG. 9 is a perspective view of a frame holding a sheet, according to an embodiment.

FIG. 10A is a perspective view of a robot arm with a stylus performing a forming operation, according to an embodiment.

FIG. 10B is a perspective view of a robot arm with a trimming performing a trimming operation, according to an embodiment.

FIG. 10C is a perspective view of a robot arm with a hemming performing a hemming operation, according to an embodiment.

FIG. 10D is a perspective view of a tool rack holding a plurality of tools, according to an embodiment.

FIG. 11 is a perspective of a third roller tool, according to an embodiment.

FIG. 12 is a perspective of fourth roller tool, according to an embodiment.

FIG. 13 includes images of two different parts made using a same part design and different forming techniques, according to an embodiment.

FIGS. 14A-14B are block diagrams of other models, according to some embodiments.

FIG. 15 is a block diagram illustrating components of an example machine able to read instructions from a machine-readable medium and execute them in a processor, according to an embodiment.

FIG. 16 is a diagram of an robotic system, according to an embodiment.

FIGS. 17A-17F (“FIG. 17” collectively) are diagrams of a tool, a tool holder, and a tool holder assembly, according to an embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

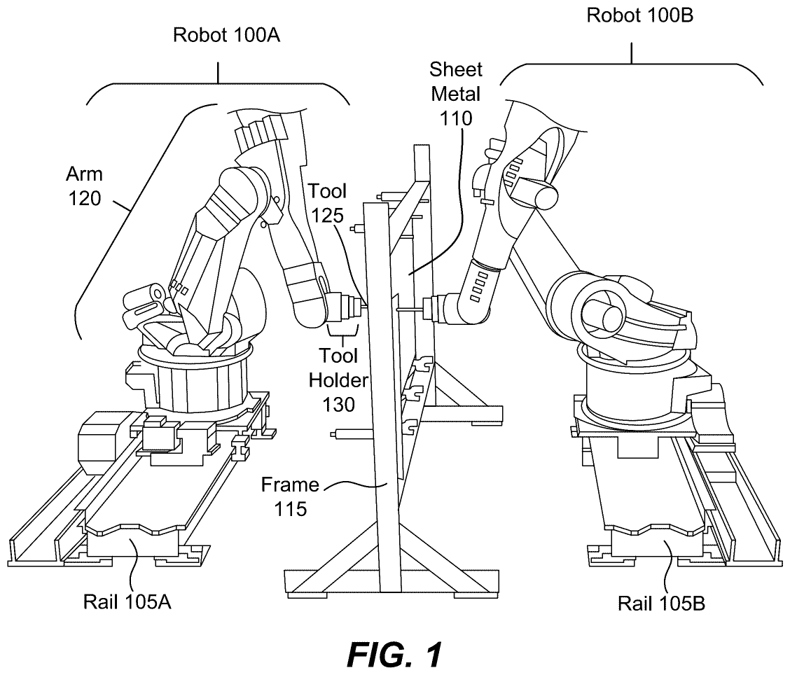

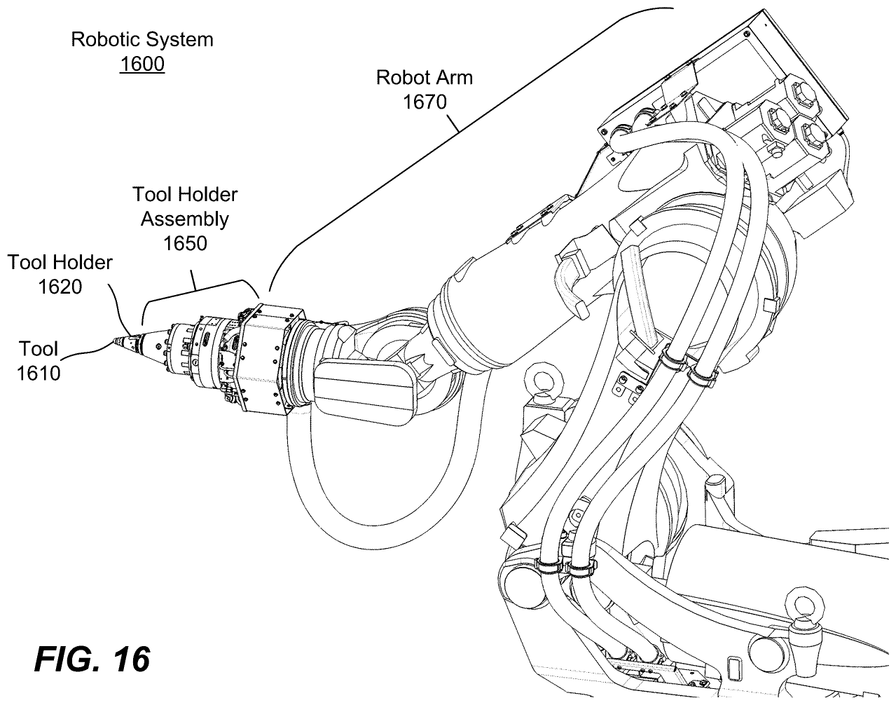

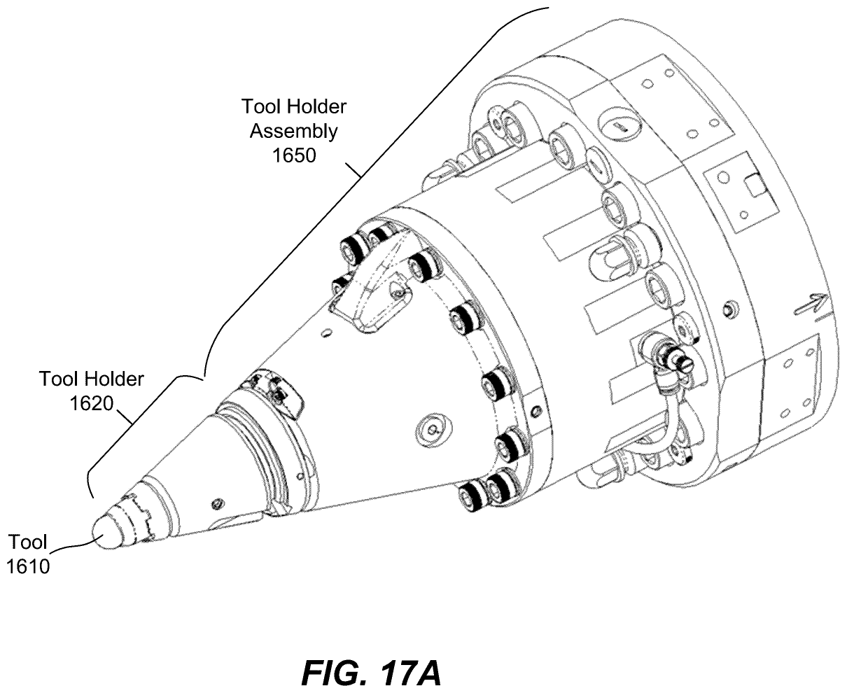

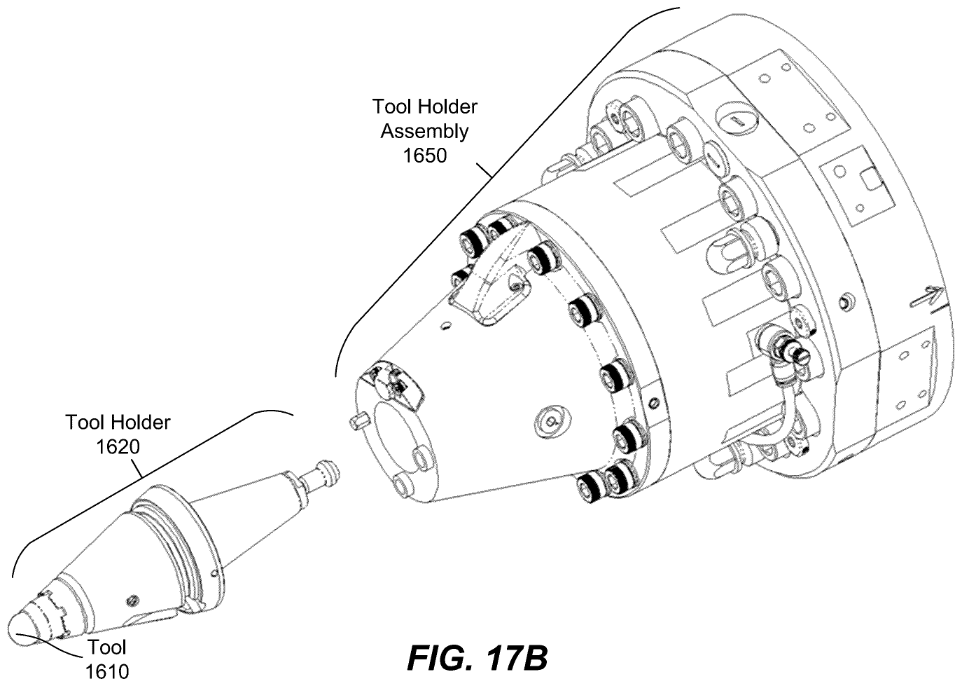

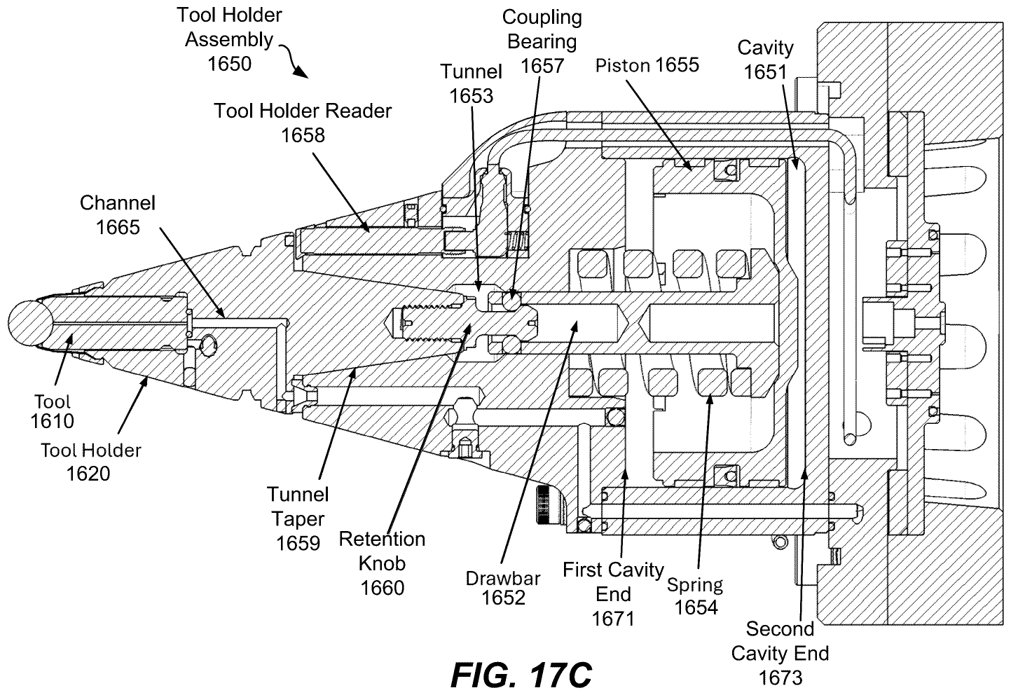

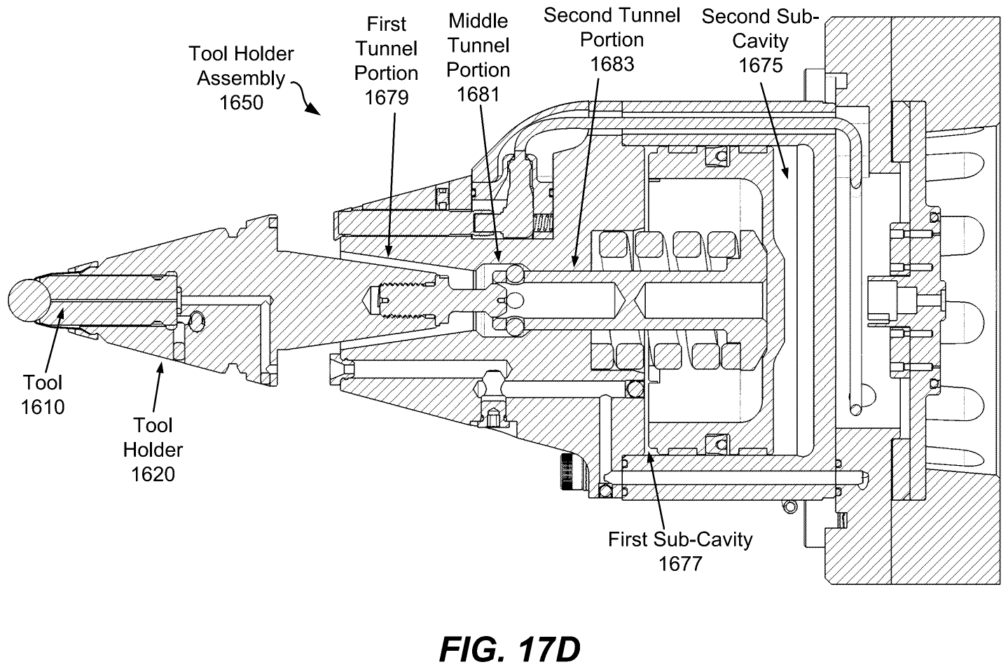

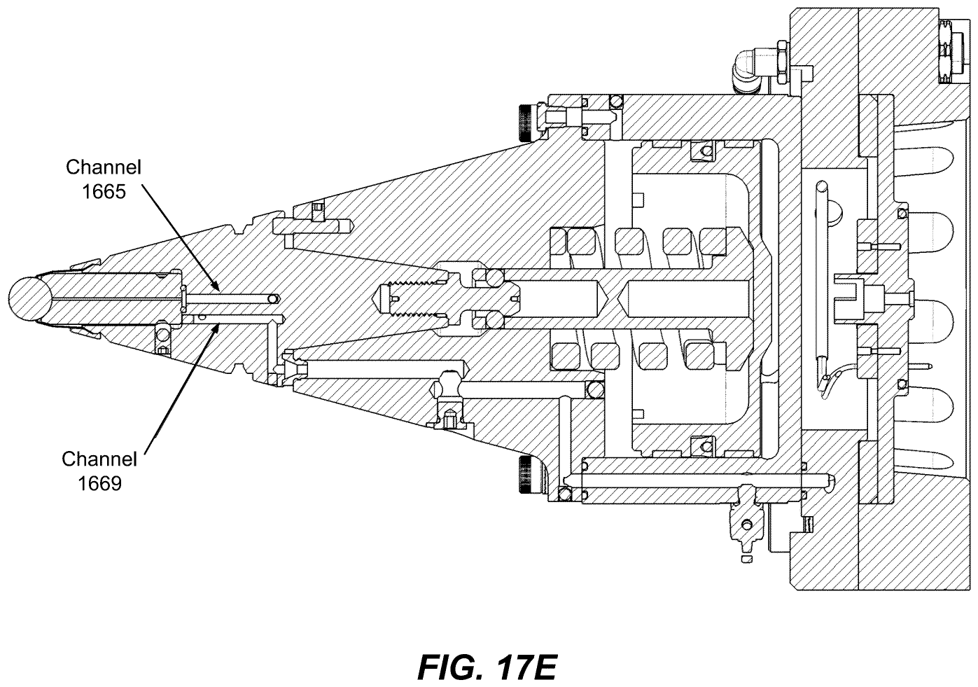

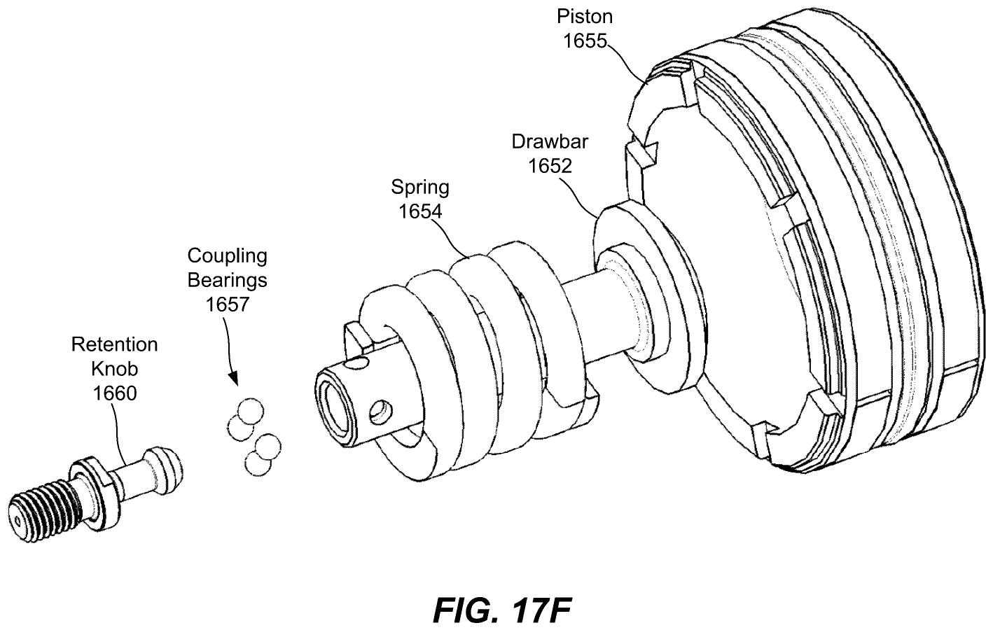

Some embodiments relate to tool holder assemblies, which are in part described below with respect to FIGS. 16-17. These tool holder assemblies may be part of a system for robotic sheet forming, which is described in part with respect to FIGS. 1-15.

In an embodiment a robotic system includes: a robot arm; a tool; a tool holder; and a tool holder assembly coupled to an end of the robot arm and configured to hold the tool holder during operation of the robotic system to form a machined part, the tool holder assembly including: an internal cavity; a drawbar in the internal cavity and extending through a tunnel at a first cavity end of the internal cavity; a spring positioned in the internal cavity to press or pull the drawbar away from the tunnel and toward a second cavity end opposite the first cavity end; a piston in the internal cavity and positioned between the drawbar and the second cavity end; and a port configured to allow fluid to enter the internal cavity between the piston and the second cavity end.

### 1. Robotic Sheet Metal Part Forming

Robotic sheet part forming is a sheet metal part forming technique where a sheet is formed into a desired geometry by a series of incremental deformations applied by a robot (e.g., a machined part). For example, the robot is outfitted with a stiff stylus that delivers deformations to the sheet. The robot may change tools to apply different operations (e.g., trimming and hemming) to the metal part. Multiple robots may be used in the process to provide more accurate control of the process.

Increasing the speed and decreasing the cost to manufacture sheet metal parts is desirable for enhancing product development in all stages of design and manufacturing. In light of this, some embodiments relate to an intelligent machine learning-based system that automates object process parameter generation for real-time control of novel robotic forming of sheet metal, plastics, polymers, and composite parts. Relative to conventional techniques, the disclosed (e.g., fast forming) techniques may enable faster prototyping and may enable rapid customization of mass-produced products. Agile production or prototyping in turn enables development of better-quality products and streamlining production. It may also increase industrial competitiveness in both mature and emerging markets by reducing the time and capital used for developing new components. The benefits may extend further for “lightweighting” strategies employed in various industries (e.g., aerospace and automotive) that want to move towards lighter and higher strength alloys but are slowed down by testing of these alloys. For simplicity, the below descriptions refer to forming parts from sheet metal. However, as indicated above, embodiments described herein may be applicable to forming parts from other materials, such as plastics, polymers, and composites.

Robotic sheet metal part forming overcomes the restrictions of the traditional methods by reducing or removing fabrication of tooling and dies from the production process. Robotic sheet part forming is a sheet metal part forming technique where a sheet is formed into a desired geometry by a series of (e.g. small) incremental deformations applied by a robot. For example, the robot is outfitted with a stiff stylus that delivers deformations to the sheet. Multiple robots may be used in the process to provide more accurate control of the deformations.

FIG. 1 illustrates an example embodiment of a setup for robotic sheet metal part forming. Two robots 100A and 100B face each other on respective rails 105A and 105B on opposite sides of the sheet metal 110. The sheet metal is supported by a frame 115 (also referred to as a fixture). Specifically, edges of the sheet metal are coupled (e.g., clamped) to the frame to hold the sheet metal in place. The sheet metal is fixed between the two robots to allow easy access from both robots to opposite sides of the sheet. The robots may be high payload industrial robotic arms that can exert forces sufficient to deform the sheet metal (e.g., up to 20,000 N). The amount of force exerted may depend on the material strength and thickness of the sheet. For example, for 2 mm 5xxx aluminum (including aluminum alloys), the peak forces may be 2,000N. In another example, for high strength martensitic steel, the peak forces may be 20,000N. The amount of force may also depend on process parameters. For example, there may be a tradeoff between time duration and force (e.g., a 1 mm stainless steel part takes 4 hours to form with a peak force of 4,000N but it takes 8 hours to form if the peak force is 3,000N). The robots may comprise an articulated 6-axis robotic arm (e.g., arm 120) capable of moving a tool (e.g., tool 125) (also referred to as an end effector) attached to the end of the arm in a three-dimensional space according to 6 degree of freedom motion. The arm may include an actuator system configured to move the robot in space. For example, each segment of the robot arm includes an actuator to move it relative to another arm segment. The end of the robot arm includes a tool holder (e.g., tool holder 130) that enables one or more selectable types of tools to be attached. The tools can include, for example, a hard stylus having ends of varying diameters, shapes, or materials, a roller tool as described below, a spindle tool, a laser tool, a plasma torch, a cutting tool, or a hole making tool. The robots are also slidable along the rails to enable the robots to operate over a wide range of sheet metal sizes and sizes of the part being fabricated. For example, the part can be as small as a few cubic inches or as big as a few cubic feet (in the volume it occupies). The robot's arms may be controlled by a controller (e.g., an external computation system) that takes into account the geometry of the final part and signals from one or more various sensors installed on the robot. The sensors may include, for example, accelerometers, gyroscopes, pressure sensors, or other sensors for detecting motion, position, and interactions of the robot with the sheet metal.

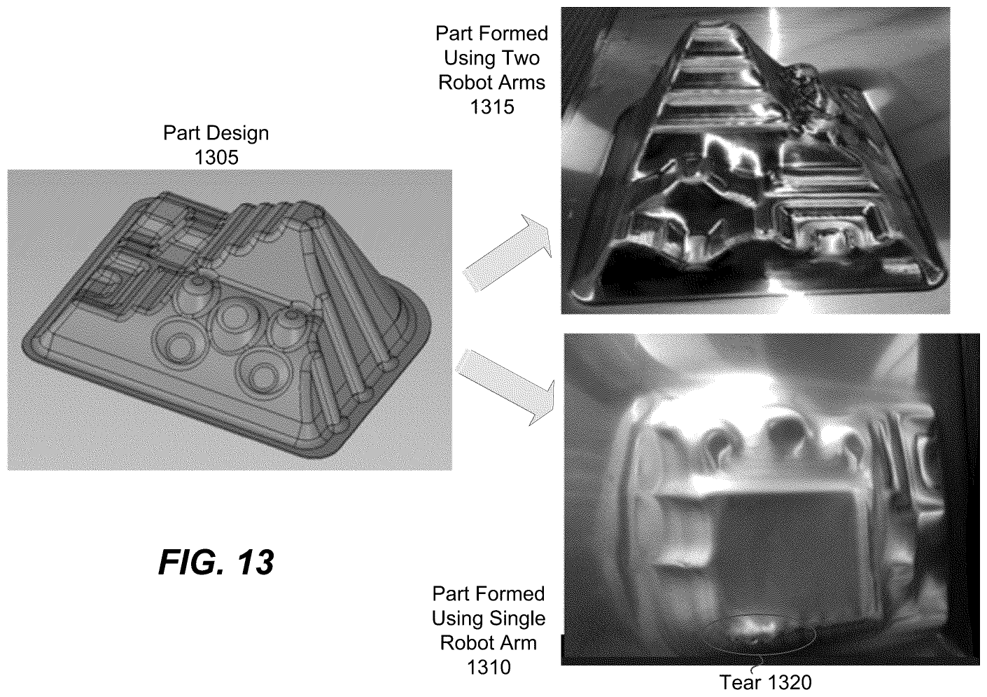

The use of two robots (one on each side of the sheet) may provide several advantages. For example, if only a single robot is used, the sheet may globally deform (instead of locally deform). Thus, using two robots may enable localized deformations. A second robot (also referred to as a support robot) may reduce or prevent tearing of the part by providing supporting pressure on the opposite side of the part. The location of the robots (and their end effectors) with respect to each other may be based on the design of the part and the material and thickness of the sheet. These locations may be determined by a model (described further below). An example of the advantages of two robots is illustrated in FIG. 13. FIG. 13 includes a part design 1305 that illustrates the design of a part to be formed. The images on the right illustrate parts formed based on the design 1305. The bottom right image illustrates a part 1310 formed using only one robot and the top right image illustrates a part 1315 formed using two robots. As illustrated, part 1315 includes more details and more closely resembles the part in 1305. Additionally, the part 1301 includes a tear 1320.

A controller may receive and process sensor data from the sensors to determine the proper parameters (e.g., joint angle values for each joint of the robotic arm) and control the robot arms accordingly. In some embodiments, the robots are controlled to pinch or otherwise apply pressure to the sheet metal with a hard implement (e.g., a stylus) or other tool to form the sheet of metal in accordance with a program applied by the controller to result in a desired geometry. For example, the program controls the robot arms to move in a particular sequence and apply the tool to the sheet metal according to particular programmed parameters at each step (e.g., time step) of the sequence to achieve a programmed geometry. The program (via the robotic arms) may cause the different applied tools to bend, pinch, cut, heat, seam, or otherwise form the metal in accordance with the program.

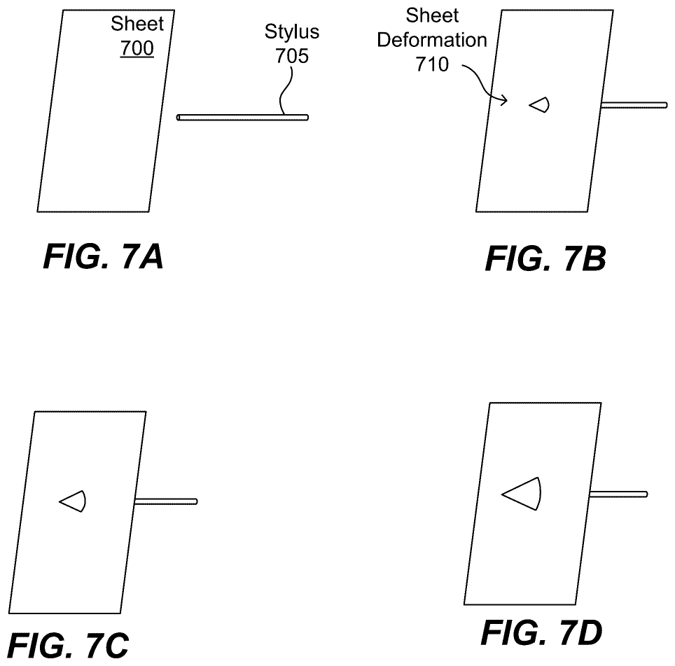

An example part forming process is illustrated in FIGS. 7A-7D. The FIGS. include a sheet 700 and a stylus 705 (e.g., coupled to a robot arm). In FIG. 7B the stylus is applied to the sheet. The result is a deformation 710. FIGS. 7C and 7D illustrate larger deformations that result from the stylus being applied to different locations on the sheet (e.g., in a spiral pattern). To facilitate the deformation into a desired geometry (e.g., a cone), a second tool (e.g., coupled to a second robot arm) may be applied to the opposite surface of the sheet.

### 2. Controller and Model

The controller determines the process parameters to achieve the desired robotic forming operations. Parameters such as the path of the robotic forming tool during the process, its speed, geometry of the forming tool, amount of force, angle and direction of the forming tool, clamping forces of the sheet, etc. may have direct but nonlinear effects on the final geometry. The part forming process may include a set of time steps, where each step describes parameters values for one or more parameters. The part forming process may be iterative. Thus, by executing the system according to the parameter values at each time step, the controller may form the part described in the input design. The parameters values may be determined by the model.

The disclosed robotic system may achieve real-time adaptive control of a part forming process. The method may start with an input design of a part and a (e.g., statistical) model that is generated using a training data set. The training data set may include data from simulation data, and physical process characterization data (such as an in-process inspection or post-build inspection from previously formed parts or geometries). An in-process inspection may include inspecting a part during the forming process. For example, a scanning sensor records the shape of the part as it is being formed. In another example, an eddy current sensor detects defects like cracks. In another example, a force sensor measures the forces applied to the part. A post-build inspection is intended to gather information on a fully formed part. A post-build inspection may include similar inspection techniques as an in-process inspection (e.g., inspecting a part using a scanning sensor or eddy current sensor). However, a post-build inspection may include inspection techniques not performed while the part is being formed (e.g., due to practicality). For example, a fully formed part may be inspected using an x-ray machine.

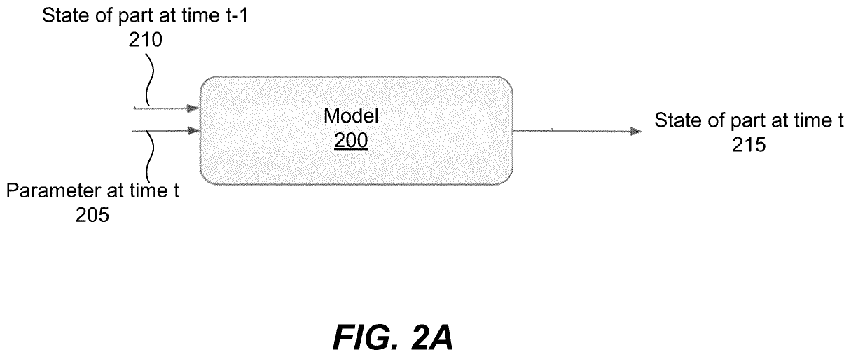

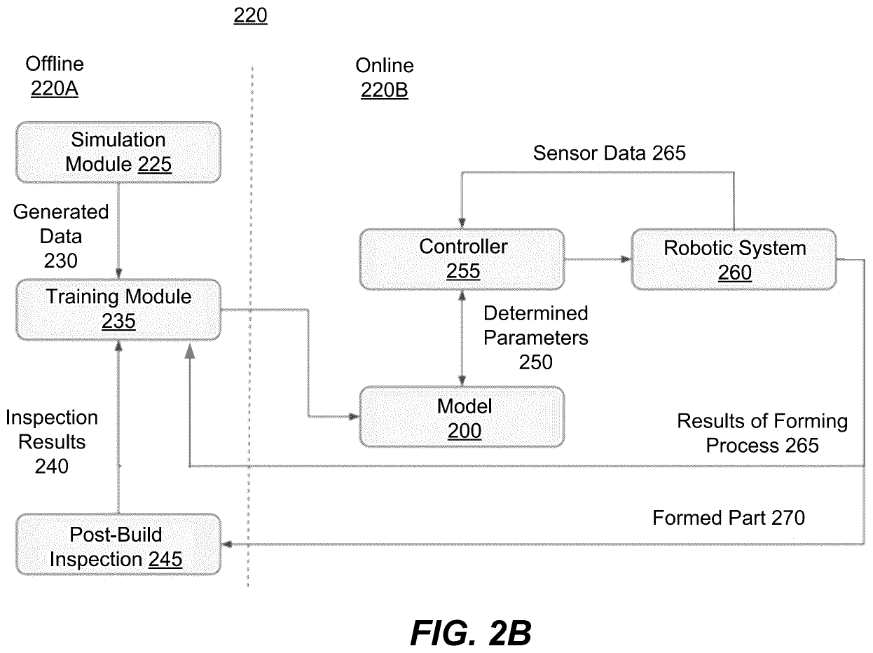

FIG. 2A is a block diagram of an example model 200. As indicated above, the model may be a machine learned statistical model. The model receives one or more parameters 205 to be applied at time step t and the state 210 of the part at time step t-1. The state may refer to the geometry of the part. The model outputs the state 215 of the part at time step t. Thus, for a given state, the model can predict how the part will respond to the application of various parameters. More generally, the model may be used to predict how a material will deform when it goes through a programmed forming process (e.g., over multiple time steps)

A state of the part may be described by a mesh. The mesh may be a graph of coupled nodes, where each node represents a physical point of the part metal. Each node may be described by the following variables: X, Y, Z, F1z, F1x, F1y, F2z, F2x, F2y, thickness, dx, dy, and dz. X, Y, and Z represent the location of the node in space. Thickness indicates the sheet thickness at that node. Each node may be coupled to neighboring nodes (e.g., three neighbors). These coupled nodes represent the part in cartesian space. F1z, F1x, and Fly represent the force that one of the robots (e.g., robot 1) is applying at that node, and F2z, F2x, F2y, represent the force another robot (e.g., robot 2) is applying at that node. dx, dy, and dz represent the size of movements capable at a node if the robots pull back from the part at this time (e.g., they capture the elastic strain of the material).

The model can be used to determine the process parameters (e.g., in real time or offline). This method automates the generation of parameters for the robotic forming process (further described in the next paragraph). Due to the optimization process, the generated parameters may not be conceivable by engineers.

After the model is determined (e.g., by a training process), optimization techniques may be used to determine parameters to apply at each (e.g., time) step of the part forming process to create the intended part geometry. For example, for a given time step, the model is applied to various input parameter values according to an optimization technique to determine which parameter values will result in a desired geometry (or a geometry close to the desired geometry). Multiple optimization techniques may be used. Example optimization techniques include gradient descent, Adam optimization, and Bayesian optimization. An optimization technique may be chosen based on the complexity of the desired geometry. The optimization may be done both in the long and short horizons (e.g., time scales). The long horizon optimization may be done offline (before the part forming process begins) to determine steps of the process (e.g., step by step instructions for the robot to achieve the desired geometry). For example, a long horizon optimization may determine how to form a material sheet into a fully formed part. In some embodiments, long horizon optimizations determine a set of intermediate geometries that occur during a part forming process (e.g., intermediate geometries between the sheet and the fully formed part (e.g., for each time step or layer)). However, errors or inaccuracies may accrue over time (e.g., for processes with lengthy build times or processes with a large number of time steps). For example, the part may deform differently than the model predicted. To remedy this issue, short horizon optimizations may be performed during the forming process (online) to reduce or correct errors that may accrue. For example, the model is queried by a (e.g., online) controller that can modify (e.g., correct) steps determined during the long horizon optimization based on the current state of the sheet. For example, for a given time step, instead of assuming the part has a geometry predicted by the long horizon optimization, sensor data may be used to determine the actual geometry of the part. The model may then be queried to determine a new set of parameter values for the time step (or modify the long horizon parameters associated with the time step). For example, the model may be queried to determine which parameter values will form the actual geometry into the predicted geometry (or another intermediate geometry from the long horizon optimization).

While long horizon optimizations may be used to determine an entire part forming process or significant portions of the process, determinations made by short horizon optimizations may be limited to small portions of the part forming process. For example, a short horizon optimization determines a number of interactions (e.g., less than ten) between the end effector and the part. In another example, a short horizon optimization determines interactions between the end effector and the part that will occur during a time window (e.g., less than ten seconds). In another example, a short horizon optimization determines parameter values for a set of time steps (e.g., less than ten time steps). In another example, a short horizon optimization determines how to form a part in a first geometry into a second geometry, where the first and second geometries are intermediate geometries determined by a long horizon optimization. In another example, a short horizon optimization is used to determine how to form a part so that it is a threshold percent closer to a final geometry (e.g., less than ten percent).

In some embodiments, a long horizon optimization is used without short horizon optimizations (e.g., the model has a threshold accuracy or the part forming process has a short build time or a small number of time steps). In some embodiments, short horizon optimizations are used without a long horizon optimization.

Referring back to the model 200, the model may be trained using the data from a simulation module. Additionally, or alternatively, the model 200 may be trained using data (e.g., sensor data) from a physical process that forms a part.

In some embodiments, multiple models are trained. For example, models may be trained using different machine learning techniques. Additionally, or alternatively, models may be trained for specific materials (e.g., steel vs. aluminum), geometries (simple vs. complex), or sheet thickness (e.g., 1 mm vs. 2 mm). Among other advantages, models trained for specific specifications may be more accurate than a general model.

FIG. 2B is a block diagram illustrating an example of the process 220. The process includes an offline learning process 220A and online process 220B. In this context, “online” refers to a time period when a part forming process is occurring (e.g., a robot is deforming a metal sheet to form a part), and “offline” refers to a time before or after a part forming process. The offline process uses simulation data 230, data 265 generated by an in-process inspection, and data 240 generated by a post-build inspection (of the formed part 270) to train model 200. Example data from an in-process inspection is metrology data. Example data post-build inspections includes geometry scans or X-rays of the finished part. After the model 200 is generated, it may be used to determine a part forming process.

The model 200 may also be applied by the controller 255 of the robotic system 260 in the online process. More specifically, the model 200 may determine predictions about the resulting change in geometry from each parameter change at each point in time in the part forming process. In the online process, the controller uses sensors installed on the robotic forming system to obtain sensor data 265 to determine a current geometry of the part. The current geometry may then be input to the model 200. The model predicts the outcome (e.g., a resulting change in geometry) of changes in those process parameters. By iterating over different possible parameters and their outcome predicted by the model, the controller identifies and chooses the (e.g., best) parameter 250 that produces the most desirable outcome to control the robotic forming system through a forming process that achieves the desired geometry. The controller uses the best parameters and may repeats this optimization cycle (e.g., in every step of the process) to improve the outcome.

In addition to the model 200 described above with respect to FIG. 2A, other models are possible. Two examples are provided below.

### 2.1 Blackbox Model

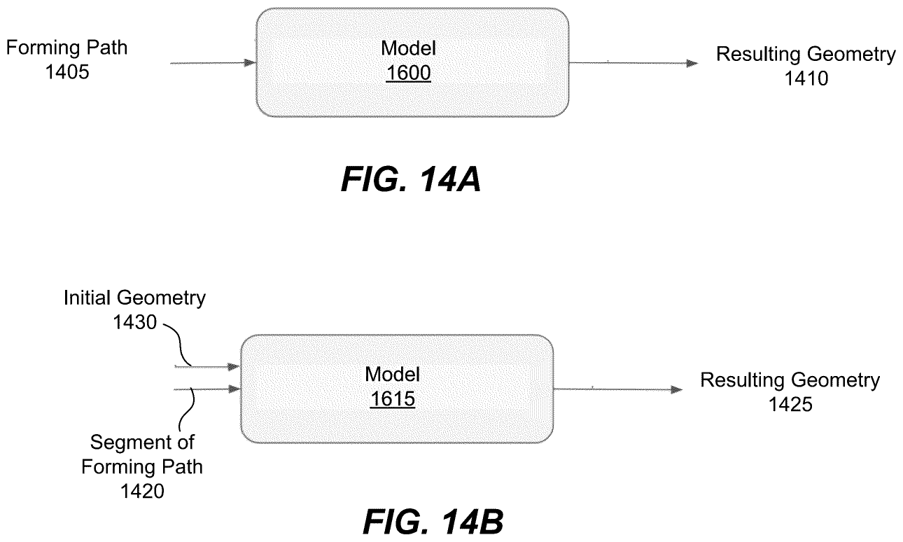

FIG. 14A illustrates an example black box model 1400. The model receives an entire forming path 1405 to be applied to a material sheet and outputs the resulting final geometry 1410 formed by the path. Thus, the model may be trained using data that describes various forming paths and the resulting part geometries. Since the model is not trained to account for physical phenomena (e.g., elastic deformation, global deformation, buckling) the model may be trained using large amounts of training data.

A more complex model is the one that breaks the forming process into layers and tries to predict the effect of various parameter values at each layer. In this context, “layer” refers to a section of a part. For example, a first layer refers to the section that extends one inch away from the original sheet and a second layer refers to the section that extends from the first inch to the second inch. An example of a layer based model is further described below.

### 2.2 Layer Based Model

FIG. 14B illustrates an example layer based model 1415. For input, the model receives a segment of a forming path 1420 and the initial geometry 1430 of a metal part (e.g., a sheet or other geometry). The segment of the forming path 1420 may include enough forming path to form a new layer of the part. The model outputs a resulting geometry 1425 (e.g., the geometry of the part with a new layer). Training data for this model may be generated by determining a forming path (e.g., set of parameter values) that formed a new layer of a part (e.g., scan every layer or every few layers).

Model 1415 may be developed as a sequence model which means it may be any of the sequence architectures (e.g., RNN, LSTM, Transformers). This model has more advantages than model 1400 since it is agnostic to general changes to the policy for forming robots. For example, model 1415 may be used to model inset adding or doing ADSIF or grouped DSIF. That being said, in some embodiments, model 1415 does not capture physical phenomena that may occur during each layer or group of layers.

### 3. Simulation

Referring back to FIG. 2B, the simulation module 225 simulates interaction of a robot-controlled tool, such as a stylus, with a sheet metal or other material. In one example, the simulation may be done using a finite element method. The simulation may be performed to generate simulation data indicating various input parameter values and resulting part geometries. The simulation may be replicated (e.g., in computer data centers) to generate large amounts of simulation data 230. The simulation speed and rate of data generation can be significantly enhanced using GPUs. The large amounts of data may be beneficial for training the model (e.g., instead of only relying on data generated from using a robot arm to physically deform a sheet).

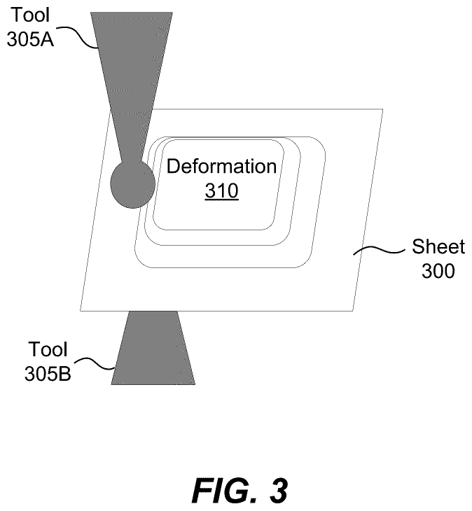

FIG. 3 illustrates an example image from a simulation. The image includes a three-dimensional simulation of a sheet 300 and two tools 305A and 305B interacting with the sheet. The tools may be coupled to robot arms. Tool 305A is interacting with the top surface of the sheet, and tool 305B (partially blocked by the sheet) is interacting with the bottom surface of the sheet. The tools are pressing into the sheet to form a deformation 310. In the example of FIG. 3, the deformation is a rectangular hill protruding upward.

Referring back to FIG. 2B, input for the simulation module 225 may be a specification for a sheet, such as its material properties (e.g., the stress—strain curve) and failure criteria (e.g., mechanical failure of the sheet). Failure criteria may be one or more rules that specify when a part has torn or cracked. The criteria may be based on thickness of the sheet, the material properties, and the amount strain put into the sheet. The simulation module may also receive a specification for one or more programmed forming paths (e.g., determined heuristically) and the type and size of the end effector (e.g., stylus). The simulation module outputs, for a sequence of time steps of the programmed control process, the resulting formed geometry.

By varying different input process parameters such as the forming path, its speed, and the geometry being formed, the simulation module 225 can generate a (e.g., large) data set indicating how a specific metal is deformed with this process (e.g., how metal deforms in response to certain input parameters). The simulation data is used to train a model (e.g., by a training module). The model may be trained using one or more different machine learning techniques and constructs, such as Neural Networks, Random Forests, Decision trees, or regressions. in some embodiments, the training techniques are supervised learning techniques.

In some embodiments, the simulation data is used to train an initial model. The initial model may then be refined or retrained using data from physical part forming processes to increase the accuracy of the model.

In the examples described above, the model is generally described in the context of forming operations. However, the model (or another model) may be trained to predict other part operations, such as trimming or hemming.

### 4. Instrumentation of Robotic Part Forming

The model created using simulation data may be further trained from data derived from an actual physical process that uses a robot arm and an actual sheet. The physical system is equipped with one or more different types of sensors. Example sensors include: (1) encoders in the robot joints that provide positional information as determined by the position of the joints, (2) optical trackers (e.g., a camera) that track the location of robot in (e.g., 3D) space, (3) surface scanners to generate as-built geometry of the part before, during, and after the forming process (surface scanners may have a point accuracy of 0.5 mm), (4) load sensors that determine the force the forming end effectors apply on the sheet, (5) ultrasonic sensors (e.g., electromagnetic acoustic transducer or EMAT) for real-time monitoring of material thickness, and (6) eddy current sensors (e.g., pulsed eddy current) for real-time monitoring of the metallurgical state of metallic sheet. In some embodiments, if the surface scanner is attached to the robot arm, surface scanner data may be stitched together based on the encoder data to determine the geometry of a part (the location of the scanner depends on the position of the arm).

The encoders may be attached to each joint on the robot to track its actual movement, the optical trackers may be mounted around the manufacturing cell. This allows the optical trackers to capture images that include tracking targets installed on the robotic arms and the frame holding the sheet in place. The load sensor and scanner may be attached to the end-of-arm tooling to track forming forces and deformation of the sheet during the process.

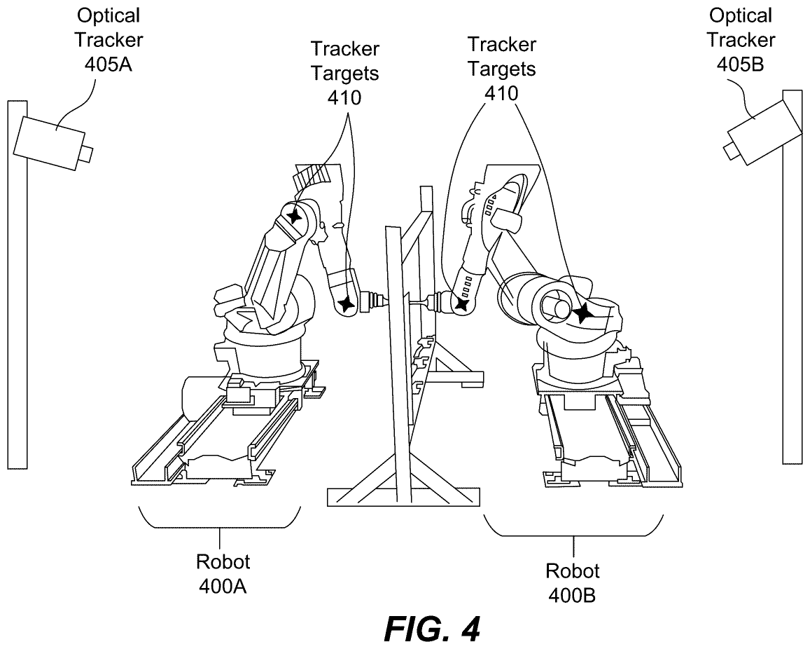

Example optical trackers are illustrated in FIG. 4. FIG. 4 includes two robots 400A and 400B in a manufacturing cell. FIG. 4 also includes two optical trackers 405A and 405B. The robots include tracker targets 410 located at various points on the robots. The optical trackers capture images of the robots and identify the locations of the tracker targets in the images. Thus, the locations of the robots in space can be determined. Although not illustrated, the sheet metal or frame may also include tracking targets to track locations of the robots relative to the metal sheet or frame.

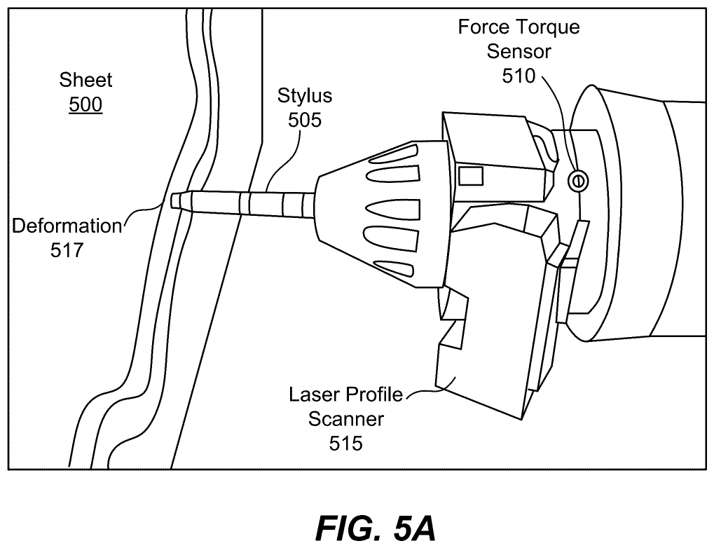

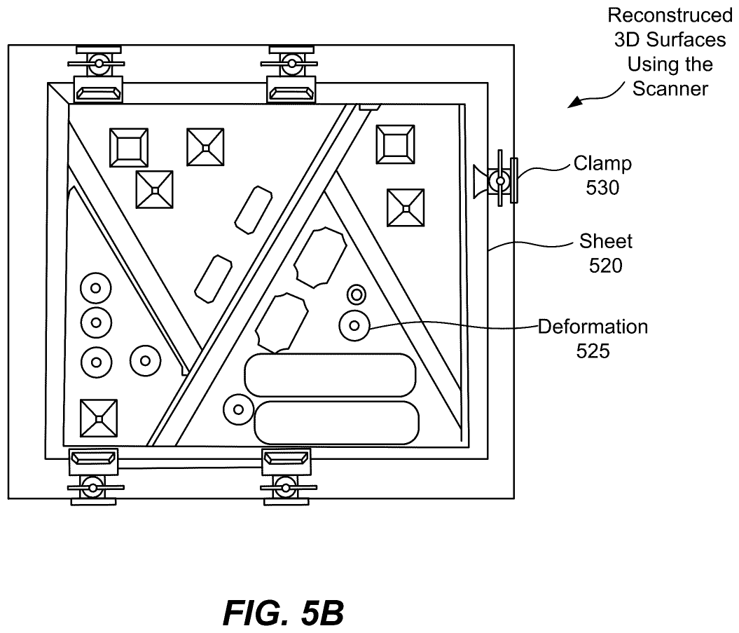

In some embodiments, the robot arm is outfitted with a scanner and a load sensor (e.g., force/torque sensor) as illustrated in FIG. 5A. FIG. 5A illustrates a zoomed in view of an end of a robot arm. The robot arm interacts with a metal sheet 500 via a stylus 505 to create a deformation 517. The arm also includes a force torque sensor 510 and a laser profile scanner 515. FIG. 5B is an example image generated using data from the laser profile scanner 515. FIG. 5B illustrates a reconstructed three-dimensional surface of the metal sheet. The image includes clamps 530, a sheet 520, and deformations 525 in the sheet.

With the sensors described above, accurate data can be captured to characterize steps of a part forming process.

Referring back to FIG. 2B, the training module 235 obtains data 230 generated by the simulation module 225 (e.g., parameters and estimated final geometry of a part for a given forming process), sensor data 265 generated during a part forming process, and data 240 generated during a post-build inspection 245 (e.g., actual final geometry of the part). The training module 235 trains a machine-learned model 200 that maps input parameters to a resulting geometry.

### 5. Using the Model in Control Loop

Once a process model 200 is generated using the above-described training process, the model may be applied in the control process of the robotic forming in two ways. The model may as an input takes a specification for a sheet, such as its material properties (e.g., stress-strain curve) and failure criteria. It may also receive a specification for forming paths (which may initially be determined offline) and the type and size of the tool. The model can be either queried online for optimized process parameters for each time step of the process in real-time, or it can be used in the design of experiments offline to determine optimal policy for forming the part. The policy here refers to general pathing strategies in forming a part.

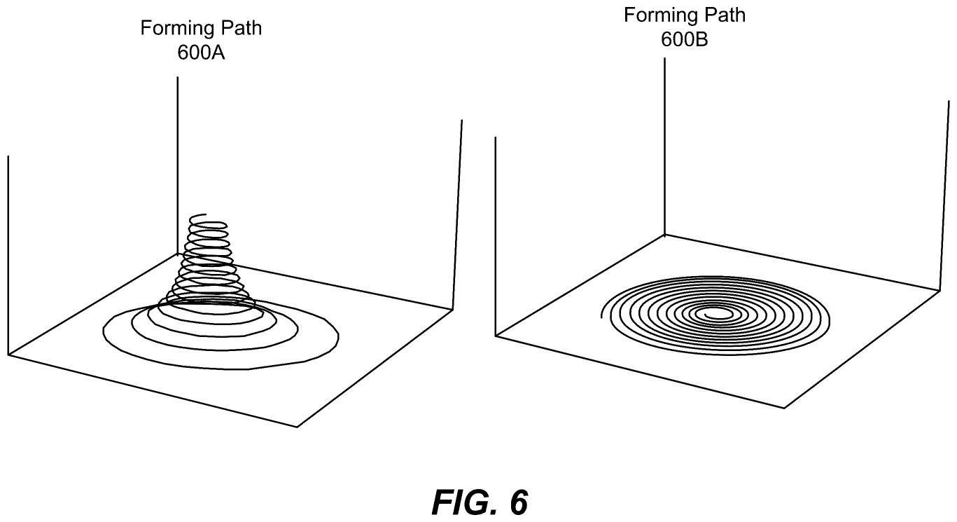

FIG. 6 illustrates two different strategies for forming a cone in an example forming process. Both can be evaluated (e.g., by the controller 255) using the machine-learned model 200 to determine a preferred path. The model can also be used (e.g., by the controller 255) to determine a combination of strategies for different locations in the part that might yield the best outcome. On the left side of FIG. 6 is a depiction of a forming path 600A that starts the forming from outside and moves in a circular pattern toward the inside of a cone (first forming the largest radius and then moving toward forming a smaller radii). On the right side of FIG. 6 is depiction of a forming path 600B that starts forming from inside and moves in a circular pattern toward the outside of a cone (first forming the tip of the cone with the smallest radius and then progressively forming larger and larger radii). The model can be used predict the outcome of both strategies to determine the best strategy or their combination for different parts.

Two categories of systems discussed below may increase the speed of sheet metal part fabrication using robots. The first system and design (“Forming With Rollers”) increases the speed of the forming process itself, while the second (“Integration of Downstream Processes”) addresses downstream processes from part forming to decrease total fabrication time.

### 6. Forming With Rollers

To increase the speed of the part forming process, an end-effector tool may be configured to interact with the sheet metal with reduced (e.g., low) friction forces. Reducing friction allows for reduction in vibrations in the sheet and hence allows increased speed of forming without negative impact on the geometrical accuracy of the formed part. It may also result in better surface quality (e.g., reduced tearing and galling) compared to tools not configured to reduce friction (e.g., static forming tools).

An example tool configured to reduce friction is a stylus made of a material (or coated with a material) configured to reduce friction. Thus, if the stylus is dragged across the surface of a part, the reduced friction may reduce or eliminate surface degradations and increase the path speed.

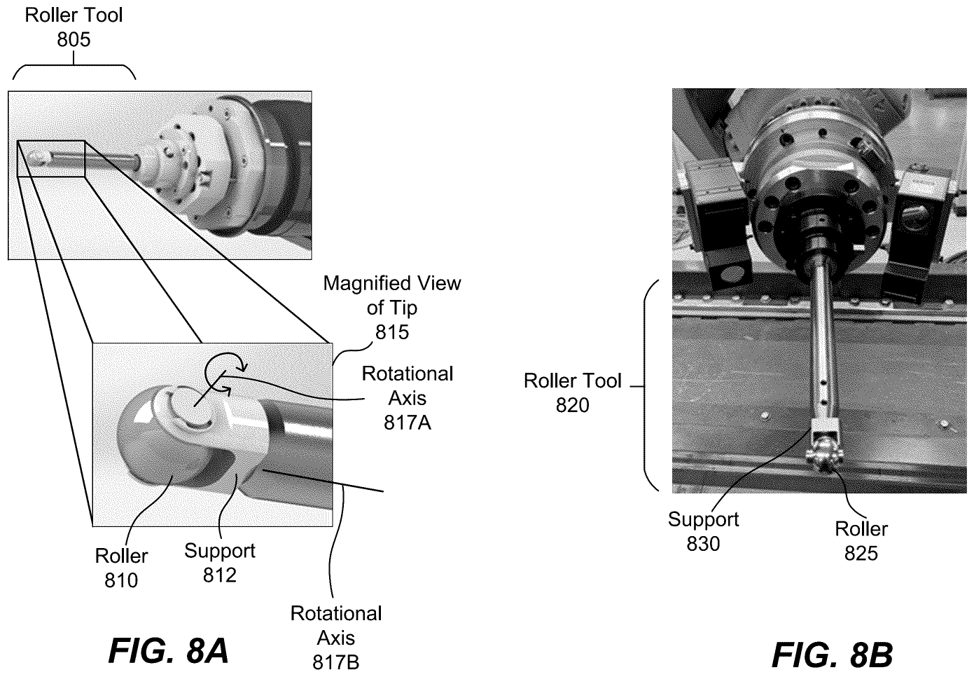

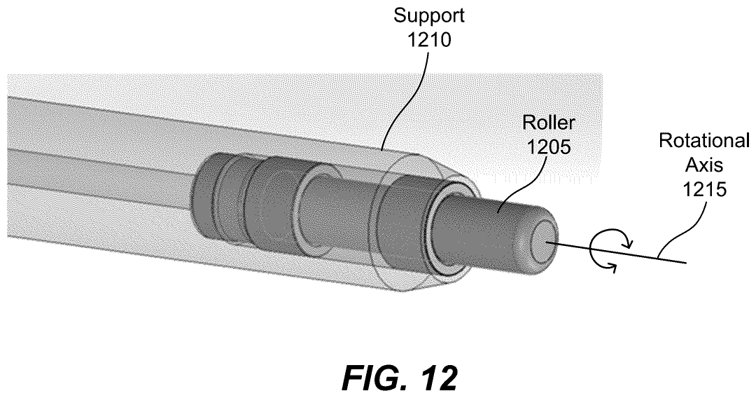

Other tools configured to reduce friction may include roller tools. Roller tools may result in lower friction forces than a stylus. Different rollers with different radii and shape can be used to accommodate for different features in the part design. FIGS. 8A-8B illustrate example embodiments of roller tools. FIG. 8A includes an image of a roller tool 805 coupled to a robot arm and a magnified view of the tip of the roller tool 815. The tip of the roller tool includes a roller 810 held in place by a support 812. The support allows the roller to rotate about an axis 817. FIG. 8B is an image of a larger roller tool 820. Similar to FIG. 8A, tool 820 has a roller 825 and a support 830. Another example of a single axis roller is illustrated in FIG. 12. The tool includes a roller 1205 with a support 1210. The roller can rotate about axis 1215, which is parallel to a long axis of the support.

In some embodiments, the roller can only roller about a single rotational axis (e.g., as in FIGS. 8A and 8B). However, the robotic system is controlled, via the controller, to orient the roller tool so that the roller rolls along the desired direction of movement (the desired direction of movement may be set by the program). Said differently, the roller tool may be oriented so that the rotational axis of the roller is perpendicular to the direction of movement of the roller tool. The illustrated rollers are specifically suitable for part forming with articulated 6-axis robots, since the robots can take advantage of the 6 degrees of freedom to align a roller in the direction of the movement during part forming. The roller may be held with the same mechanism as the stylus or other tools using a tool holder that is mounted at the end of the robotic arm.

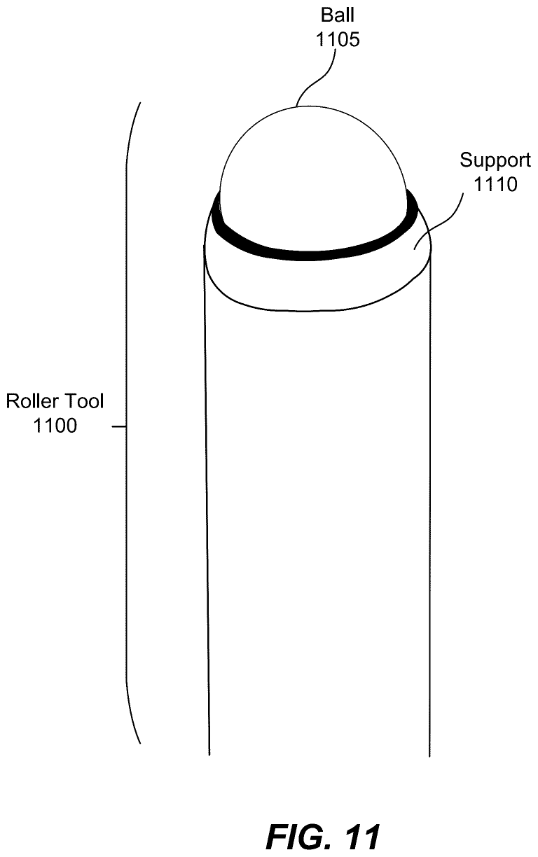

In some embodiments, a roller tool includes a roller that can rotate about multiple rotational axes. An example, of this is illustrated in FIG. 11. FIG. 11 includes a roller tool 1100. The tool 1100 includes a ball 1105 in a socket that may be part of a support 1110 for the ball. The ball can rotate in the socket. Thus, the tool can move in different directions along a part surface without the robot rotating the support along the long axis. Due to the socket configuration, the roller tool 1100 have less friction than a stylus but more friction than a single axis roller (e.g., as illustrated in FIGS. 8A and 8B).

The disclosed roller design installed on a robotic setup allows for robotic part forming with reduceds friction, hence reduced forces which then allows for better surface quality of the formed part and increased speed of the forming process.

### 7. Integration of Downstream Processes in the Forming Setup

Sheet metal part forming may be one of many manufacturing steps performed to produce a final sheet metal part. For example, a sheet metal part also goes through trimming, hole making, hemming, or other processing steps after the part forming process. Traditional methods involve transferring a sheet metal part from one specialized manufacturing station to another, performing each manufacturing step in each corresponding station to produce the delivering the final part. This results in increased manufacturing time due to the time for physically moving the part from one station to another.

Each of the downstream processes generally has its own specific tooling. For example, for trimming a part, it is desirable to use a geometry specific frame that can hold the geometry of the part while a trimming operation is performed.

In some embodiments, the robotic system allows for performing two or more (e.g., all) downstream manufacturing steps in the same station using the same robotic setup, thus avoiding moving of the part and decreasing the total fabrication time. Each downstream process may use a different tool. For example, when performing trimming (e.g., hole making), the robot arm may attach different tools such as a spindle, laser, or a plasma torch. The robotic arm can be controlled to automatically change the tool through software instructions of the program executed by the controller (e.g., controller 255). For example, the controller can control the robot arm at varying times throughout the process to perform a programmed operation on the sheet metal with a particular tool, to control an actuator to release a tool from the tool holder (e.g., into a tool rack), and to cause the robot arm to attach a new tool from the tool holder (e.g., from the tool rack) for performing a subsequent operation.

In some embodiments, the steps that enable automatic integration of downstream processes in the same station may include the following. (1) the robot goes to a tool rack and picks up a forming tool (e.g., a stylus) using predefined software instructions sent to the robot. (2) the robot forms a part from a flat sheet of metal through software defined path and parameters. (3) After the part is formed, the robot moves back to the tool rack, disengages (e.g., drops) the forming tool, and picks up a trimming tool. This step may also be automated with software instructions. (4) The robot performs a trimming operation on the part with the trimming tool. If further downstream processes, such as hemming (e.g., bending), are used to finish the part, the system may continue from step 3 until no more processes are left to perform. If a station includes multiple robots, the robots may work in conjunction using the same or different tools to achieve a desired process (e.g., a forming or trimming process).

If a manufacturing area includes multiple cells (e.g., each including two robot arms), instead of each cell changing tools to perform different operations, each cell may be assigned to a specific operation. In these embodiments, a part may be moved from one cell to another after each operation on the part is complete.

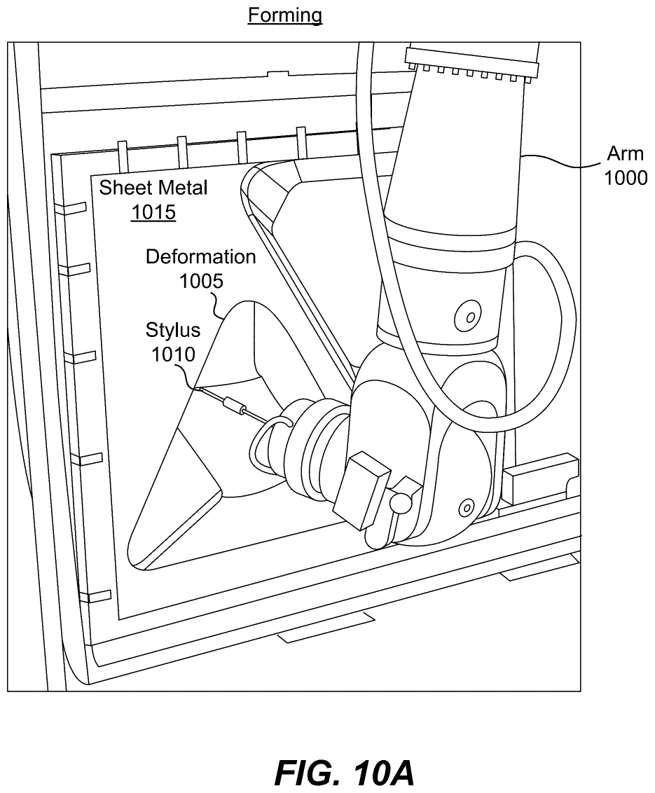

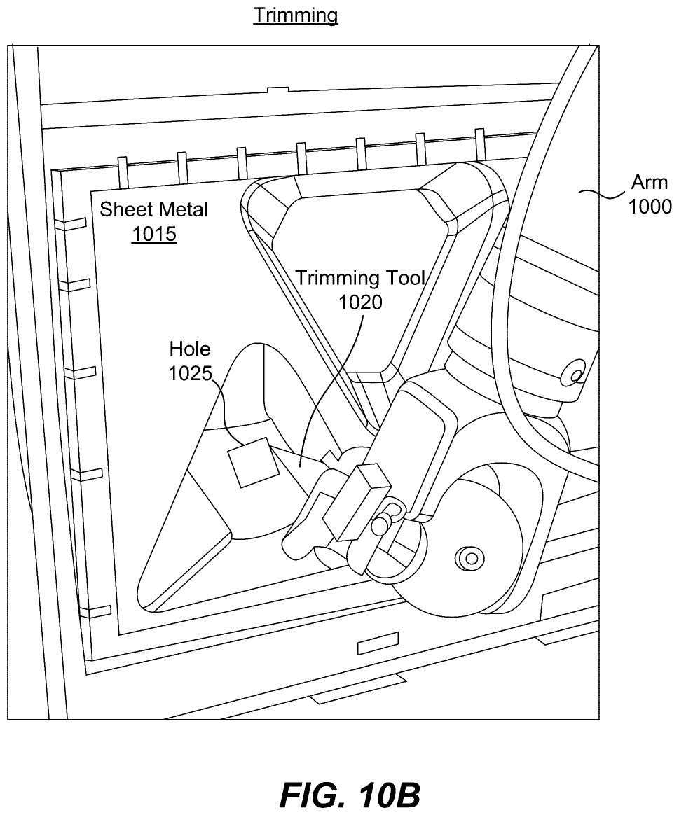

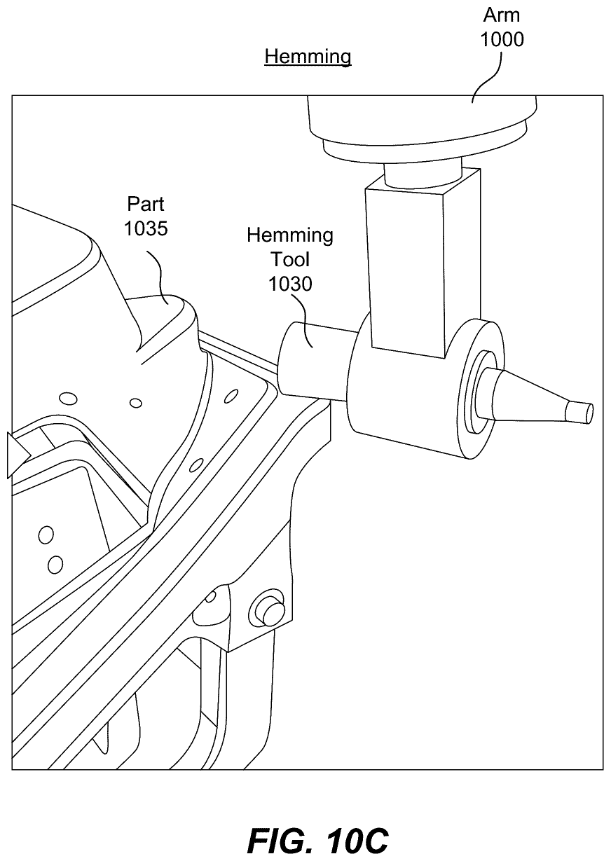

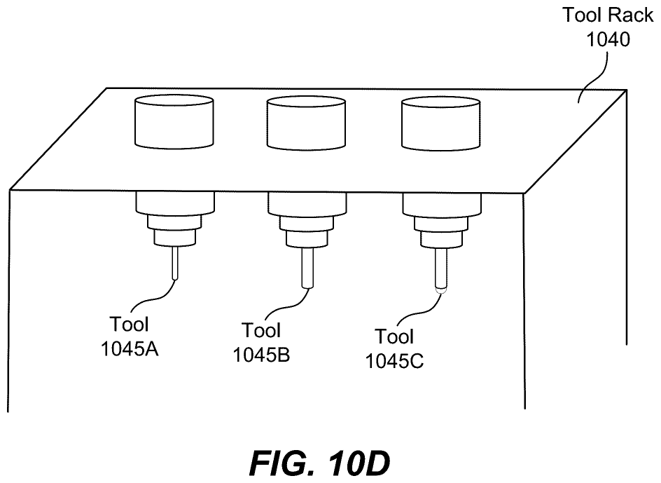

FIG. 10 includes images of various manufacturing processes described above. FIG. 10A illustrates a robot arm 1000 forming a deformation 1005 by pressing a stylus 1010 against a piece of sheet metal 1015. FIG. 10B illustrates the robot arm 1000 with a trimming tool 1020. The trimming tool is used to cut a hole 1025 in a portion of the deformation. To determine the location of the hole, a controller of the arm (e.g., controller 255) may compare a design of the deformation (e.g., in a computer-aided design file) with the current geometry of the deformation (the current geometry may be determined from sensor data). For example, after the deformation is formed, the robot picks up a scanner sensor, scans the deformation and, based on a design of the deformation, determines the path to trim the deformation. After that, the robot may pick up a trimming tool. FIG. 10C illustrates the robot arm 1000 with a hemming tool 1030. The hemming tool is used to bend a corner of a part 1035. FIG. 10D is a perspective view of a tool rack 1040 holding a plurality of tools 1045. The rack may be placed near a robot arm (e.g., arm 1000) so that the arm can exchange tools. In the example of FIG. 10D, tools 1045A and 1045B are styli and tool 1045C is a roller tool.

### 8. Frame

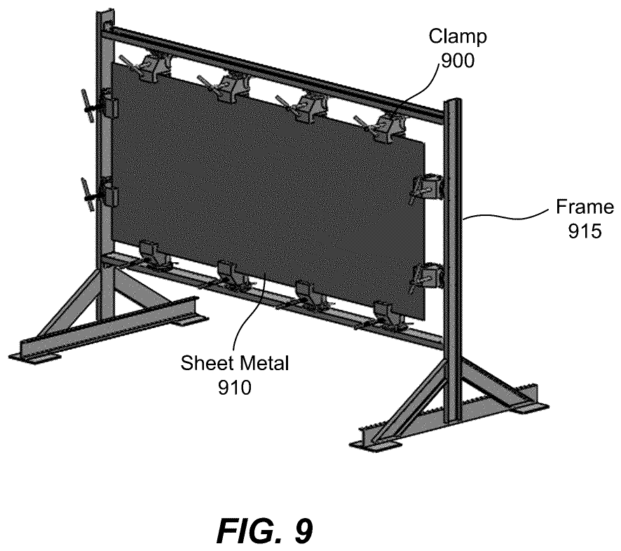

FIG. 9 is a perspective view of a frame 915 (also referred to as a fixture), according to an embodiment. In the example of FIG. 9, the frame 915 includes a series of clamps 900 that hold the sheet metal 910 in place. Specifically, the frame surrounds the edges of the sheet metal and the clamps are clamped to edge portions of the sheet metal 910. The clamps may be hydraulic or electric (e.g., servo). The clamps may be electronically operated. The frame and clamps may be sturdy enough to hold the sheet metal in place as the robot arms apply different processes (e.g., deformation forces) to the sheet. The frame enables access to large sections of the sheet metal 910 with robotic arms. Thus, it may eliminate the need for any method-specific modification in the fixture that is traditionally required with downstream operation from sheet forming.

Thus, the stand design and software-controlled tool changer for controlling the robotic arms allows for automated downstream operations from forming of the sheet metal parts such as trimming, bending, and hemming without removing the part from the fixture and requiring geometry specific fixture.

### 9. Tool Holder Assemblies

FIG. 16 is a diagram of part of an example robotic system 1600 configured to form a part, according to an embodiment. Robotic system 1600 includes tool 1610, tool holder 1620, tool holder assembly 1650, and robot arm 1670. Tool 1610 is held in place by tool holder 1620. Tool holder assembly 1650 is coupled to an end of robot arm 1670. Tool holder assembly 1650 is configured to hold tool holder 1620 during operation of the robotic system 1600 to form the part. However, tool holder assembly 1650 enables tool holder 1620 to be removed and replaced with a new tool holder, thus allowing quick and convenient tool changing (as opposed to replacing an entire assembly including a tool, tool holder, and tool holder assembly). To do this, tool holder assembly 1650 may include a fluid tool holder release system (e.g., a pneumatic tool holder release system), however other systems may be used as well. Additionally, tool holder assembly 1650 may be configured to receive tool holders with standard tool interfaces, such as CAT40 or BT40, can may lower costs and complexity.

FIGS. 17A-17F (“FIG. 17” collectively) are diagrams of tool holder assembly 1650, tool holder 1620, and tool 1610, according to an embodiment. More specifically, FIG. 17A is a perspective view, where tool holder 1620 is attached to tool holder assembly 1650. FIG. 17B is a perspective view, where tool holder 1620 is detached from tool holder assembly 1650. FIG. 17C is a cross sectional view of, where tool holder 1620 is attached to tool holder assembly 1650. FIG. 17D is a cross sectional view, where tool holder 1620 is detached from tool holder assembly 1650. FIG. 17E is a cross sectional diagram illustrating additional passages (e.g., vacuum passage 1667 and coolant passage 1669) in tool holder assembly 1650 relative to FIGS. 17C and 17D. FIG. 17F is an exploded view diagram of select parts of tool holder assembly 1650. More specifically, FIG. 17F is an exploded view that includes retention knob 1660, coupling bearings 1657, spring 1654, drawbar 1652, and piston 1655.

Tool 1610 is configured to interface with an object (e.g., a piece of sheet metal) to perform part forming operations. Tool holder 1620 is a mechanical device designed to securely hold and support tool 1610. Tool holder 1620 includes an interface configured to interlock with tool holder assembly 1650. In some embodiments, tool holder 1620 has a CAT40 interface or a BT40 interface.

Tool holder assembly 1650 is a mechanical device configured to hold tool holder 1620 during operation of the robotic system. Tool holder assembly 1650 is coupled to an end of robot arm 1670. Tool holder assembly 1650 includes internal cavity 1651 with first cavity end 1671 and second cavity end 1673. A part of drawbar 1652, the spring 1654, and the piston 1655 are located in cavity 1651. Cavity 1651 is cylindrical in the example of FIG. 17, however other shapes may be used. Cavity 1651 provides a space for components to move and perform their function, such as holding or releasing the tool holder 1620.

Tool holder assembly 1650 also includes internal tunnel 1653. Tunnel 1653 includes rounded sides although other shaped sides are possible. Tunnel 1653 extends from an end of tool holder 1620 to an end of internal cavity 1651. Tunnel 1653 includes first tunnel portion 1679 at the left side of tool holder assembly 1650 (in the perspective of FIGS. 17C and 17D), second tunnel portion 1683 connected to first cavity end 1671, and middle tunnel portion 1681 between first tunnel portion 1679 and second tunnel portion 1683. First tunnel portion 1679 may receive a receiving portion of tool holder 1620. That is, a receiving portion of tool holder 1620 may rest in first tunnel portion 1679. For example, if tool holder 1620 includes a specific interface, such as a CAT40 interface, first tunnel portion 1679 may be shaped to receive that interface (e.g., taper 1659 of first tunnel portion 1679 is configured to receive a CAT40 interface). A portion of drawbar 1652 may rest in second tunnel portion 1683, which enables ends of tool holder 1620 and drawbar 1652 to interlock with each other in middle tunnel portion 1681. Middle tunnel portion 1681 may have a dimension (e.g., diameter) larger than the corresponding dimension of second tunnel portion 1683.

Drawbar 1652 is a mechanical component that may interlock with an end of tool holder 1620 (e.g., to securely hold the tool holder 1620). Drawbar 1652 includes a first end that rests in tunnel 1653 and a second end in cavity 1651. Drawbar 1652 is designed to move along tunnel 1653 and within internal cavity 1651 (e.g., horizontally in FIG. 17C).

Spring 1654 is positioned in the internal cavity 1651 to press or pull the drawbar 1652 away from the tunnel 1653 and toward a second cavity end 1673 (which is opposite first cavity end 1671). In the example of FIG. 17, a first end of spring 1654 rests against first cavity end 1671 and the second end of spring 1654 rests against the end of drawbar 1652 within internal cavity 1651 to push 1652 away from tunnel 1653. In the example of FIG. 17, spring 1654 is a single helical spring, however multiple springs and/or other types of springs may be used. The stiffness of spring 1654 may depend on the forces used to keep tool holder 1620 coupled to tool holder assembly 1650 during part forming operations.

Piston 1655 is positioned in internal cavity 1651 between the drawbar 1652 and the second cavity end 1673. Due to spring 1654 applying a force to move drawbar 1652 toward second cavity end 1673, spring 1654 may press drawbar 1652 against piston 1655. In some embodiments, piston 1655 and drawbar 1652 are a singular component. Piston 1655 can move within internal cavity 1651 between first cavity end 1671 and second cavity end 1673. Piston 1655 is sized to form a seal within internal cavity 1651 that divides internal cavity 1651 into two sub-cavities (i.e., first sub-cavity 1677 between first cavity end 1671 and piston 1655 and second sub-cavity 1675 between second cavity end 1673 and piston 1655). More specifically, side edges of piston 1655 may form a seal with one or more side walls of 1651 cavity (depending on the shape of internal cavity 1651). Thus, if pressure in one of the sub-cavities increases, the increased pressure may move piston 1655 in internal cavity 1651 such that the volume of one sub-cavity increases and the other sub-cavity decreases. Note that the seal does not need to be a perfect fluid-tight seal. The seal may simply be strong enough to move piston 1655 when pressure in one of the sub-cavities changes (e.g., subject to the force from 1654).

Tool holder assembly 1650 includes a port (not illustrated) to internal cavity 1651. Port can allow fluid (e.g., a liquid or gas (e.g., air)) or to enter or exit internal cavity 1651. Port is positioned to allow fluid to enter or exit the internal cavity between piston 1655 and the second cavity end 1673 (i.e., second sub-cavity 1675).

As previously mentioned, tool holder assembly 1650 enables tool holder 1620 to be locked into or released from tool holder assembly 1650 based on the position of drawbar 1652. If drawbar 1652 translates into tunnel 1653 past a threshold (referred to as drawbar 1652 being at an “unlocked position”), interlocking mechanisms between drawbar 1652 and tool holder 1620 enable tool holder 1620 to be released from tool holder assembly 1650. However, if drawbar 1652 translates toward second cavity end 1673 past a threshold (referred to as drawbar 1652 being at a “locked position”), interlocking mechanisms between drawbar 1652 and tool holder 1620 may prevent tool holder 1620 from being released from tool holder assembly 1650 (assuming drawbar 1652 remains in the locked position).

To enable this, in the example of FIG. 17, tool holder 1620 includes retention knob 1660 (e.g., a CAT40 retention knob) and drawbar 1652 includes coupling bearings 1657 (however, other mechanisms may be used in other embodiments). In this example, the unlocked position is when drawbar 1652 is positioned in tunnel 1653 such that coupling bearings 1657 are in middle tunnel portion 1681. This enables coupling bearings 1657 to move due to middle tunnel portion 1681 having a larger dimension (e.g., diameter) than second tunnel portion 1683 (e.g., see FIG. 17D). This positioning enables retention knob 1660 to move past coupling bearings 1657 (e.g., to remove tool holder 1620 from first tunnel portion 1679 or insert tool holder 1620 into first tunnel portion 1679. The locked position is when drawbar 1652 is positioned in tunnel 1653 such that coupling bearings 1657 are in second tunnel portion 1683. This results in coupling bearings 1657 being restricted by the smaller dimension of second tunnel portion 1683, which prevents retention knob 1660 from moving past coupling bearings 1657 (e.g., see FIG. 17C). Thus, to remove or insert tool holder 1620 into tool holder assembly 1650, drawbar 1652 may be moved to the unlocked position, and to lock tool holder 1620 into tool holder assembly 1650, drawbar 1652 may be moved to the locked position.

When pressure in second sub-cavity 1675 is low (e.g., below a first threshold based on the stiffness of spring 1654), spring 1654 moves drawbar 1652 into the locked position (if drawbar 1652 was in the unlocked position) and applies a force that keeps drawbar 1652 in the locked position (e.g., during part forming operations). However, when pressure in second sub-cavity 1675 is increased (e.g., by fluid being pumped into second sub-cavity 1675 via the port), the increased pressure applies an increasing force against spring 1654. If the pressure becomes high enough to overcome spring 1654 (e.g., above a second threshold based on the stiffness of spring 1654), the pressure moves piston 1655 along internal cavity 1651 toward first cavity end 1671 (and thus pushes drawbar 1652 further into tunnel 1653), which may result in drawbar 1652 moving to the unlocked position. Note that fluid through the port may be controlled by a fluid power system (e.g., a hydraulic or pneumatic system) of robotic system 1600.

Many alternative tool holder assemblies are possible. In a first example, tool holder assembly 1650 may include a second port that allows fluid (e.g., liquid or gas) to enter or exit first sub-cavity 1677. Thus, the position of drawbar 1652 and piston 1655 may be controlled by controlling the fluid pressures in first sub-cavity 1677 and second sub-cavity 1675 (e.g., drawbar 1652 and 1655 may be coupled together). In some of these embodiments, spring 1654 may be removed. In a second example alternative tool holder assembly, spring 1654 may be moved to second sub-cavity 1675 and arranged to push piston 1655 toward first cavity end 1671 and the port may be moved to allow fluid to enter or exit first sub-cavity 1677 (e.g., drawbar 1652 and 1655 may be coupled together). In a third example, second sub-cavity 1675 may include an actuator configured to push piston 1655 toward first cavity end 1671 (and thus push drawbar 1652 further into tunnel 1653). The actuator may be in addition to or alternative to controlling fluid pressure in second sub-cavity 1675.

In some embodiments, tool holder 1620 and tool holder assembly 1650 include channels (e.g., 1665 and 1669). Channels may be used to carry fluid to or from tool 1610 (e.g., during part forming). For example, channel 1665 may be a vacuum passage that helps retain the ball at the end of tool 1610. In another example, channel 1669 may carry coolant to reduce or prevent tool 1610 from overheating during part forming operations.

In some embodiments, tool holder assembly 1650 includes tool holder reader 1658, such as an RFID (radio-frequency identification) sensor. Thus, a control system of robotic system 1600 may use signals from tool holder assembly 1650 to confirm whether a tool holder is installed in tool holder assembly 1650 and/or confirm which tool holder is installed in tool holder assembly 1650 (since many different tools many be used and performing operations with a wrong tool holder can be problematic).

### 10. Additional Example Tool Holder Assemblies

Additional examples of tools, tool holders, and tool holder assemblies are described below. Although references are made to FIGS. 16-17 in the below descriptions, the example embodiments described below are not required to include the components or features previously described with respect to those figures.

Some embodiments relate to a robotic system (e.g., 1600), for example configured to form a (e.g., machined) part, the robotic system including: a robot arm (e.g., 120, 1000, 1670); a tool (e.g., 125, 505, 705, 805, 1010, 1100 1610); a tool holder (e.g., part of 130, 1620); and a tool holder assembly (e.g., part of 130, 1650). The tool holder assembly is coupled to an end of the robot arm and configured to hold the tool holder during operation of the robotic system to form the part, the tool holder assembly including: an internal cavity (e.g., 1651); a drawbar (e.g., 1652) in the internal cavity and extending through a tunnel (e.g., 1653) at a first cavity end (e.g., 1671) of the internal cavity; a spring (e.g., 1654) positioned in the internal cavity to press or pull the drawbar away from the tunnel and toward a second cavity end (e.g., 1673) opposite the first cavity end; a piston (e.g., 1655) in the internal cavity and positioned between the drawbar and the second cavity end; and a port configured to allow fluid to enter the internal cavity between the piston and the second cavity end (e.g., in 1675).

In some aspects, fluid pressure in the internal cavity between the piston and the second cavity end higher than a threshold pressure causes the piston to move toward the first cavity end (e.g., see the movement of the piston and drawbar in the transition from FIG. 17D to 17C). In some aspects, the threshold pressure depends on the stiffness of the spring.

In some aspects, fluid pressure in the internal cavity between the piston and the second cavity end higher than a threshold pressure causes the piston to press the drawbar into the tunnel at the first cavity end. In some aspects, translation of the drawbar into the tunnel past a threshold releases the tool holder from the tool holder assembly (e.g., translation such that coupling bearings 1657 are in middle tunnel portion 1681). In some aspects, the robotic system further includes a fluid power system (e.g., a hydraulic system and/or pneumatic system) configured to pump fluid through the port and into the internal cavity (e.g., a hose in FIG. 16 is part of the hydraulic system and carries fluid to tool holder assembly 1650).

In some aspects, a first end of the drawbar is in the tunnel and a second end is in the internal cavity; and at least a portion of the spring is positioned between the first cavity end and the second end of the drawbar (e.g., see FIGS. 17C and 17D). In some aspects, the spring causes the drawbar to press against the piston. In some aspects, the spring presses or pulls the drawbar toward a locked position configured to hold the tool holder to the tool holder assembly. In some aspects, force from the spring is configured to cause the tool holder to remain interlocked with the tool holder assembly during operation of the robotic system to form the part.

In some aspects, an end of tunnel is configured to receive the tool holder (e.g., first tunnel portion 1679). In some aspects, the tool holder is configured to be held in the tunnel by the drawbar during operation of the robotic system. In some aspects, the tool holder includes a retention knob (e.g., 1660) configured to interlock with an end of the drawbar in the tunnel.

In some aspects, the robotic system (e.g., the robot arm) further includes: an actuator system configured to control motion of the robot arm through space during operation of the robotic system to form the part. In some aspects, the tool is configured to press into material of the part to form the part.

In some aspects, the tool holder assembly and/or tool holder include a set of channels (e.g., 1665, 1669) configured to carry fluid to or away from the tool. In some aspects, the tool holder further includes a tool holder reader configured to scan the tool holder (e.g., 1658). In some aspects, the tool holder has a CAT40 interface (e.g., including 1660). In some aspects, the tool holder assembly is configured to receive a tool holder with a CAT40 interface (e.g., first tunnel portion 1679 includes a taper (e.g., 1659) that is a CAT40 taper configured to interface with a CAT40 interface.

In some aspects, the tool, the tool holder, and the tool holder fit within a cone shaped design envelop, with the tool being near or at the tip of the cone envelope. Among other advantages, the cone shaped design envelop increases the available angles (in other words, a part forming operation can be performed at a larger angle relative to the surface without the tool holder or tool holder assembly contacting the surface of the object or otherwise hindering the part forming operation). Generally, the smaller the radius of the cone and the larger the height of the cone, the larger the part forming angle can be.

Other aspects include components, devices, systems, improvements, methods, processes, applications, computer readable mediums, and other technologies related to any of the above.

### 11. Example Machine Architecture

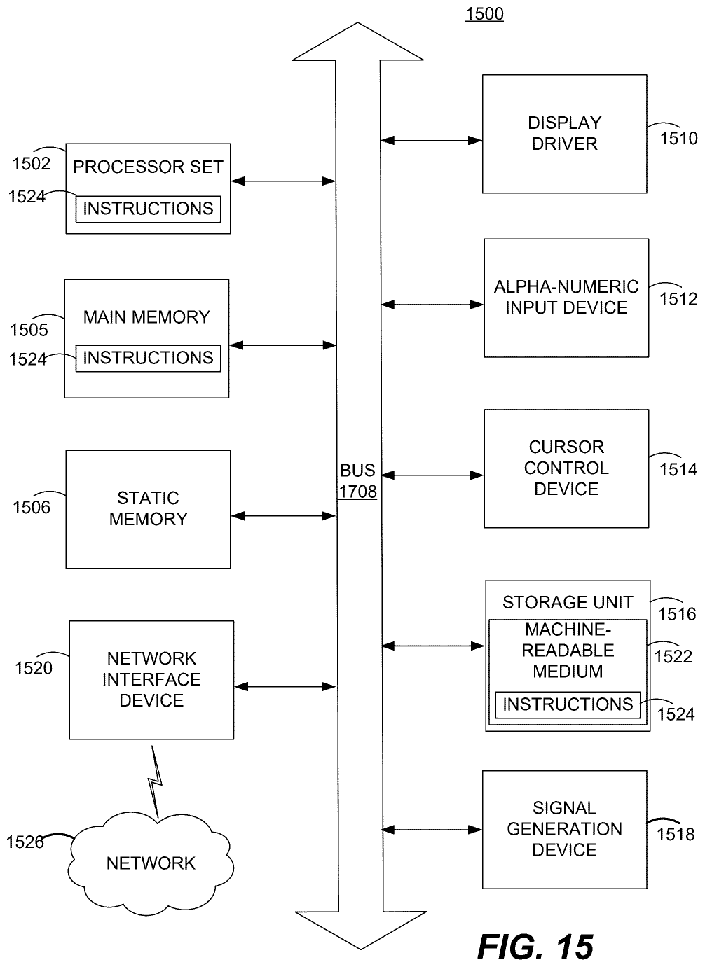

In some embodiments, the controller (e.g., controller 255 or controller 1120) is a machine able to read instructions from a machine-readable medium and execute them in a set of one or more processors. FIG. 15 is a block diagram illustrating components of an example machine able to read instructions from a machine-readable medium and execute them in a set of one or more processors. Specifically, FIG. 15 shows a diagrammatic representation of a machine in the example form of a computer system 1500. The computer system 1500 can be used to execute instructions 1524 (e.g., program code or software) for causing the machine to perform any one or more of the methodologies (or processes) described herein. In alternative embodiments, the machine operates as a standalone device or a coupled (e.g., networked) device that connects to other machines. In a networked deployment, the machine may operate in the capacity of a server machine or a client machine in a server-client network environment, or as a peer machine in a peer-to-peer (or distributed) network environment. Here, the robots, e.g., 400A, 400B, and other automated components may include all or a portion of the component of the described computer system (or machine) 1500. The robots, e.g., 400A, 400B, and/or other automated components may be programmed with program code to operate as described with e.g., FIGS. 1-14B. Such operation also include program code corresponding to the disclosed models, e.g., 1400, 1415, for effecting the resulting geometries through the robots, e.g., 400A, 400B and other automated components.

The machine may be a server computer, a client computer, a personal computer (PC), a tablet PC, a smartphone, an internet of things (IoT) appliance, a network router, or any machine capable of executing instructions 1524 (sequential or otherwise) that specify actions to be taken by that machine. Further, while only a single machine is illustrated, the term “machine” shall also be taken to include any collection of machines that individually or jointly execute instructions 1524 to perform any one or more of the methodologies discussed herein.

The example computer system 1500 includes a processing system comprising a set of one or more processing units 1502 (“processor set 1502”). The processor set 1502 is, for example, one or more central processing units (CPUs), one or more graphics processing units (GPUs), one or more tensor processing units, one or more neural network processing units, one or more digital signal processors (DSPs), one or more state machines, one or more application specific integrated circuits (ASICs), one or more radio-frequency integrated circuits (RFICs), or any combination of these. If the processor set 1502 include multiple processors, the processors may operate individually or collectively. The processor set 1502 also may be a controller. The controller may include a non-transitory computer readable storage medium that may store program code to operate (or control) the robots, e.g.,400A, 400B, and/or other automated components described herein.

For convenience, the processor 1502 is referred to as a single entity but it should be understood that the corresponding functionality may be distributed among multiple processors using various ways, including using multi-core processors, assigning certain operations to specialized processors (e.g., graphics processing units), and dividing operations across a distributed computing environment. Any reference to a processor 1502 should be construed to include such architectures.

The computer system 1500 also includes a main memory 1504. The computer system may include a storage unit 1516. The processor 1502, memory 1504 and the storage unit 1516 communicate via a bus 1508.

In addition, the computer system 1500 can include a static memory 1506, a display driver 1510 (e.g., to drive a plasma display panel (PDP), a liquid crystal display (LCD), or a projector). The computer system 1500 may also include alphanumeric input device 1512 (e.g., a keyboard), a cursor control device 1514 (e.g., a mouse, a trackball, a joystick, a motion sensor, or other pointing instrument), a signal generation device 1518 (e.g., a speaker), and a network interface device 1520, which also are configured to communicate via the bus 1508.

The storage unit 1516 includes a machine-readable medium 1522 on which is stored instructions 1524 (e.g., software) embodying any one or more of the methodologies or functions described herein. The instructions 1524 may also reside, completely or at least partially, within the main memory 1504 or within the processor 1502 (e.g., within a processor's cache memory) during execution thereof by the computer system 1500, the main memory 1504 and the processor 1502 also constituting machine-readable media. The instructions 1524 may be transmitted or received over a network 1526 via the network interface device 1520.

While machine-readable medium 1522 is shown in an example embodiment to be a single medium, the term “machine-readable medium” should be taken to include a single medium or multiple media (e.g., a centralized or distributed database, or associated caches and servers) able to store the instructions 1524. The term “machine-readable medium” shall also be taken to include any medium that is capable of storing instructions 1524 for execution by the machine and that cause the machine to perform any one or more of the methodologies disclosed herein. The term “machine-readable medium” includes, but not be limited to, data repositories in the form of solid-state memories, optical media, and magnetic media.

While machine-readable medium 722 (also referred to as a computer-readable storage medium) is shown in an embodiment to be a single medium, the term “machine-readable medium” should be taken to include a single medium or multiple media (e.g., a centralized or distributed database, or associated caches and servers) able to store the instructions 724. The term “machine-readable medium” shall also be taken to include any medium that is capable of storing instructions 724 for execution by the machine and that cause the machine to perform any one or more of the methodologies disclosed herein. The term “machine-readable medium” shall also be taken to be a non-transitory machine-readable medium. The term “machine-readable medium” includes, but not be limited to, data repositories in the form of solid-state memories, optical media, and magnetic media.

### 12. Additional Considerations

Embodiments of the system and/or method can include every combination and permutation of the various system components and the various method processes.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. In some cases, a module can be implemented in hardware, firmware, or software.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise. Where values are described as “approximate” or “substantially” (or their derivatives), such values should be construed as accurate +/−10% unless another meaning is apparent from the context. From example, “approximately ten” should be understood to mean “in a range from nine to eleven.”

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by any claims that issue.

What is claimed is:

1. A robotic system comprising:
a robot arm;
a tool;
a tool holder; and
a tool holder assembly coupled to an end of the robot arm and configured to hold the tool holder during operation of the robotic system to form a part, the tool holder assembly comprising:
an internal cavity;
a drawbar in the internal cavity and extending through a tunnel at a first cavity end of the internal cavity;
a spring positioned in the internal cavity to press or pull the drawbar away from the tunnel and toward a second cavity end opposite the first cavity end;
a piston in the internal cavity and positioned between the drawbar and the second cavity end; and
a port configured to allow fluid to enter the internal cavity between the piston and the second cavity end.

2. The robotic system of claim 1, wherein fluid pressure in the internal cavity between the piston and the second cavity end higher than a threshold pressure causes the piston to move toward the first cavity end.

3. The robotic system of claim 2, wherein the threshold pressure depends on the stiffness of the spring.

4. The robotic system of claim 1, wherein fluid pressure in the internal cavity between the piston and the second cavity end is higher than a threshold pressure to cause the piston to press the drawbar into the tunnel at the first cavity end.

5. The robotic system of claim 1, wherein translation of the drawbar into the tunnel past a threshold releases the tool holder from the tool holder assembly.

6. The robotic system of claim 1, further comprising a fluid power system configured to pump fluid through the port and into the internal cavity.

7. The robotic system of claim 1, wherein:
a first end of the drawbar is in the tunnel and a second end is in the internal cavity; and
at least a portion of the spring is positioned between the first cavity end and the second end of the drawbar.

8. The robotic system of claim 1, wherein the spring causes the drawbar to press against the piston.

9. The robotic system of claim 1, wherein the spring presses or pulls the drawbar toward a locked position configured to hold the tool holder to the tool holder assembly.

10. The robotic system of claim 1, wherein force from the spring is configured to cause the tool holder to remain interlocked with the tool holder assembly during operation of the robotic system to form the part.

11. The robotic system of claim 1, wherein an end of tunnel is configured to receive the tool holder.

12. The robotic system of claim 11, wherein the tool holder is configured to be held in the tunnel by the drawbar during operation of the robotic system.

13. The robotic system of claim 12, wherein the tool holder comprises a retention knob configured to interlock with an end of the drawbar in the tunnel.

14. The robotic system of claim 1, further comprising: an actuator system configured to control motion of the robot arm through space during operation of the robotic system to form the part.

15. The robotic system of claim 1, wherein the tool is configured to press into material of the part to form the part.

16. The robotic system of claim 1, wherein the tool holder assembly further comprises a set of channels configured to carry fluid to or away from the tool holder.

17. The robotic system of claim 1, wherein the tool holder further comprises a tool holder reader configured to scan the tool holder.

18. The robotic system of claim 1, wherein the tool holder has a CAT40 interface.

19. The robotic system of claim 1, wherein the tool holder assembly is configured to receive a tool holder with a CAT40 interface.

20. The robotic system of claim 1, wherein the tool, the tool holder, and the tool holder fit within a design envelop with dimensions.
